(19) United States
(12) Patent Application Publication
(10) Pub. No.: US 2026/0035590 A1
(43) Pub. Date: Feb. 5, 2026

(54) ABRASION RESISTANT COATING COMPOSITIONS AND FILLER PACKAGES FOR THE SAME

(71) Applicant: AXALTA COATING SYSTEMS IP CO., LLC, Wilmington, DE (US)

(72) Inventors: William Edward Hale, High Point, NC (US); Michael Alan Deal, Kernersville, NC (US); James Michael Wall, Kernersville, NC (US)

(73) Assignee: AXALTA COATING SYSTEMS IP CO., LLC, Wilmington, DE (US)

(21) Appl. No.: 19/238,839

(22) Filed: Jun. 16, 2025

Related U.S. Application Data
(60) Provisional application No. 63/677,913, filed on Jul. 31, 2024.

(51) Int. Cl. C09D 133/14; C09D 7/40; C09D 7/61; C09D 7/65

(52) U.S. Cl. CPC C09D 133/14; C09D 7/61; C09D 7/65; C09D 7/69

(57) ABSTRACT

Coating compositions and filler packages for use in coating compositions are provided herein. In an embodiment, a coating composition comprises a hydroxyl-functional resin having a plurality of free hydroxyl groups, a crosslinking agent having a hydroxyl-reactive functional group, a solvent, an inorganic particulate component, and a wax powder. The inorganic particulate component has a D90 nominal particle dimension of from about 12 microns to about 22 microns, as measured using a sieve in accordance with ASTM 5861-07 (2017).

### CROSS REFERENCE TO RELATED APPLICATION

This claims priority to U.S. Provisional Application No. 63/677,913, filed Jul. 31, 2024, the content of which is incorporated herein by reference.

### TECHNICAL FIELD

The present disclosure generally relates to coating compositions and filler packages for use in coating compositions. The present disclosure more particularly relates to coating compositions that are abrasion resistant upon curing and filler packages for use in such coating compositions.

### BACKGROUND

Coating compositions are used in various applications, including household cabinets and appliances, automotive refinishing, building materials, and industrial applications. Coating compositions are applied to a substrate, and upon curing, form a film, or coating, over one or more surfaces of the substrate. Coating compositions may provide a range of benefits when applied to a substrate. For example, coatings may add color or other aesthetic properties, and/or provide protection against exposure to certain chemicals or environmental conditions.

For many consumer products, particularly cabinetry, customers have long valued characteristics of coatings such as durability, long-lasting color, resistance to chipping and peeling, and resistance to dirt and cleaning products. Recently, there has been an increased demand for coatings that are resistant to abrasions such as scratches and scrapes. Current coating compositions that are useful for articles that may be subject to abrasion often do not meet customer specifications for abrasion resistance without compromising other properties.

Use of additives in coating compositions to improve properties such as hardness in the resulting cured films is known in the field. However, known additives may not improve the hardness or other physical properties enough to meet customer requirements for abrasion resistance. Known additives may also cause diminution of other important properties of the coating composition, making it difficult to handle and apply the coating composition through existing application methods such as spray application or brush application.

Accordingly, it is desirable to provide coating compositions, and filler packages for coating compositions, that can be effectively applied using existing application equipment and that, upon curing, form a film having maximized abrasion resistance. Furthermore, other desirable features and characteristics of the present disclosure will become apparent from the subsequent detailed description and the appended claims, taken in conjunction with the accompanying drawings and this background.

### BRIEF SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Coating compositions, filler packages for coating compositions, composite articles including a film formed from the coating compositions, and methods of forming composite articles are provided herein. In an embodiment, a coating composition comprises a hydroxyl-functional resin having a plurality of free hydroxyl groups, a crosslinking agent having a hydroxyl-reactive functional group, a solvent, an inorganic particulate component, and a wax powder. The inorganic particulate component has a D90 nominal particle dimension of from about 12 microns to about 22 microns, as measured using a sieve in accordance with ASTM 5861-07 (2017).

In another embodiment, a filler package comprises an inorganic particulate component and a wax powder. The inorganic particulate component has a hardness value of from about 4 to about 8 on the Mohs hardness scale and a D90 nominal particle dimension of from about 12 microns to about 22 microns, as measured using a sieve in accordance with ASTM 5861-07 (2017). The wax powder has a softening point of from about 150° C. to about 180° C. and an average nominal particle dimension of from about 20 microns to about 25 microns, as measured using a sieve in accordance with ASTM 5861-07 (2017).

### DETAILED DESCRIPTION

The following detailed description is merely exemplary in nature and is not intended to limit the present disclosure or the application and uses thereof. Furthermore, there is no intention to be bound by any theory presented in the preceding background or the following detailed description.

Coating compositions and filler packages for use in coating compositions are provided herein. The coating compositions can be effectively handled and applied using conventional application equipment and, upon curing to form a film, exhibit maximized resistance to abrasions such as scratches and scrapes. It has been found that including a filler package including both an inorganic particulate component having a D90 nominal particle dimension of from about 12 microns to about 22 microns, as measured using a sieve in accordance with ASTM 5861-07 (2017), and a wax powder, to a coating composition comprising a hydroxyl-functional resin having a plurality of free hydroxyl groups, a crosslinking agent having a hydroxyl-reactive functional group, and a solvent improves the abrasion resistance of the coating to meet customer specifications without compromising the ease of handling and application of the coating composition.

Unless specifically stated or obvious from context, as used herein, the term “about” is understood as within a range of normal tolerance in the art measured using standard measurement devices for a given measurement, for example within 2 standard deviations of the mean for a particular measurement device. “About” can be understood as within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

As used herein, “abrasion” refers to physical deterioration or damage to the surface of an object. Abrasions may include scratches, scrapes, scuffs, and/or other similar marks. Abrasions may be the result of wear over time, or abrasions may be the result of a discrete event such as forceful rubbing or scratching against another object.

As used herein, “nominal dimension” refers to a reference dimension of a particle. If the particle is a sphere, then the nominal dimension is defined as the diameter of the spherical particle. If the particle is not a sphere, then the nominal dimension is defined as the largest dimension of the particle.

As used herein, the “average nominal particle dimension” or “D50 nominal particle dimension” refers to a measurement below which the nominal dimension of 50% of the particles by volume in the population falls. As used herein, the “D90 nominal particle dimension” refers to a measurement below which the nominal dimension of 90% of the particles by volume in the population falls. As described herein, D50 and D90 nominal particle dimensions are measured using a sieve in accordance with ASTM 5861-07 (2017).

The coating compositions provided herein comprise a hydroxyl-functional resin having a plurality of free hydroxyl groups; a crosslinking agent having a hydroxyl-reactive functional group; a solvent; an inorganic particulate component having a D90 nominal particle dimension of from about 12 microns to about 22 microns, as measured using a sieve in accordance with ASTM 5861-07 (2017); and a wax powder.

The hydroxyl-functional resin having a plurality of free hydroxyl groups is included in the coating composition as one of two components that react upon curing to form a substantially crosslinked thermoset polymer film. The free hydroxyl groups in the hydroxyl functional resin are capable of reacting, under certain conditions, to form crosslinks. The crosslinks contribute to the setting up of the coating composition to form a coating.

In embodiments, the hydroxyl-functional resin may have a weight average molecular weight of from about 6,000 Daltons to about 30,000 Daltons, as measured by gel permeation chromatography (GPC). In embodiments, the hydroxyl-functional resin may have a glass transition temperature (Tg) from about 10° C. to about 60° C. As used herein, the “glass transition temperature” (Tg) is defined as the temperature at which a differential scanning calorimeter (DSC) trace peaks, as measured with a scan rate of 10° C./min. In embodiments, the hydroxyl-functional resin may have a hydroxyl number of from about 50 mg KOH/g to about 150 mg KOH/g, or alternatively from about 140 mg KOH/g to about 190 mg KOH/g. As used herein, the “hydroxyl number,” which may also be referred to as the “OH number” or “OH value,” refers to the mass in milligrams of potassium hydroxide (KOH) required to neutralize the acetic acid taken up on acetylation of one gram of a chemical substance that contains free hydroxyl groups. As used herein, the hydroxyl number is analyzed by titration in accordance with the standard test method ASTM D4274-11.

In embodiments, the hydroxyl-functional resin is chosen from acrylic resins, alkyd resins, polyester resins, hydroxyl-functional polyepoxide resins, polyesterurethane resins, urea- formaldehyde resins, or a combination thereof. Examples of acrylic resins include linear, branched, grafted, and/or segmented polyacrylates or polymethacrylates. Examples of polyesters include polycarbamates and branched copolyesters. In embodiments, the hydroxyl-functional resin comprises oligomers. In embodiments, the hydroxyl-functional resin comprises an acrylic alkyd resin, which is relatively susceptible to abrasion, but which provides other desirable properties, including resistance to moisture and chemicals, resistance to radiation, adhesion, flexibility, resistance to yellowing, and fast drying.

In embodiments, the hydroxyl-functional resin is present in an amount of from about 5 wt % to about 50 wt %, alternatively from about 7 wt % to about 35 wt %, alternatively from about 7 wt % to about 30 wt %, alternatively from about 10 wt % to about 28 wt %, based on a total weight of the coating composition.

The crosslinking agent having a hydroxyl-reactive functional group is included in the coating composition to facilitate crosslinking of the hydroxyl-functional resin. In embodiments, the crosslinking agent has one hydroxyl-reactive functional group. In embodiments, the crosslinking agent has two or more hydroxyl-reactive functional groups. In embodiments, the crosslinking agent has an equivalent weight of from about 25 grams/eq. to about 250 grams/eq., alternatively from about 50 grams/eq. to about 100 grams/eq. As used herein, the “equivalent weight” refers to the mass of the crosslinking agent that contains one equivalent of reactive functional groups (i.e. the molar mass of the crosslinking agent divided by the number of reactive functional groups per molecule of the crosslinking agent). In embodiments, the crosslinking agent is selected from polyisocyanates, blocked polyisocyanates, melamines, melamine derivatives, benzoguanamines, silanes, epoxides, and combinations thereof. An example of a melamine derivative is an alkylated melamine. In embodiments, the crosslinking agent is a melamine-formaldehyde resin.

In embodiments, the crosslinking agent is present in an amount of from about 0.5 wt % to about 30 wt %, alternatively from about 1 wt % to about 25 wt %, alternatively from about 2 wt % to about 21 wt %, alternatively from about 4 wt % to about 10 wt %, based on a total weight of the coating composition.

In embodiments, the coating composition is a 1k composition. As used herein, a “1k composition” is defined as a single package system wherein all elements of the coating composition are included in one package, and the coating composition cures upon exposure to certain conditions. When a 1k coating composition is stored in a can or other closed container, the hydroxyl-reactive functional group of the crosslinking agent does not react with the free hydroxyl groups in the hydroxyl-functional resin. This allows the coating composition to remain in the can without curing. However, upon exposure to certain conditions, including heat, the hydroxyl-reactive functional group of the crosslinking agent reacts with the free hydroxyl groups in the hydroxyl-functional resin, causing crosslinking of the resin and curing of the coating composition to form a film. In embodiments, the coating composition is a 2k composition. As used herein, a “2k composition” is defined as a two package system wherein elements of the coating composition are included in two separate packages, and the two packages are combined before application of the coating composition, which cures upon combination and/or upon exposure to certain conditions.

The solvent is included in the coating composition for a variety of purposes. For example, the solvent may facilitate dissolution of the other elements of the coating composition, help control the dynamic viscosity of the coating composition, improve the adhesion of the coating to a substrate, and/or contribute to the stability and shelf life of the coating composition. The coating composition may contain only one solvent, or alternatively, the coating composition may contain more than one solvent.

The solvent may be an organic solvent or an aqueous solvent. An example of an aqueous solvent is water. Examples of organic solvents include acetone, alcohols such as isopropyl alcohol or isobutyl alcohol, ketones such as methyl amyl ketone or methyl isobutyl ketone, acetates such as butyl acetate or propylene glycol monomethyl ether acetate, and aromatic or aliphatic hydrocarbon solvents. The solvent may be polar or nonpolar. The appropriate type of solvent may be selected based on the nature of the other elements present in the coating composition.

In embodiments, the solvent is present in an amount of from about 10 wt % to about 80 wt %, alternatively from about 20 wt % to about 70 wt %, alternatively from about 30 wt % to about 60 wt %, alternatively from about 40 wt % to about 50 wt %, based on a total weight of the coating composition.

Filler packages are provided herein that can be included in a coating composition. The filler packages comprise an inorganic particulate component having a D90 nominal particle dimension of from about 12 microns to about 22 microns, as measured using a sieve in accordance with ASTM 5861-07 (2017), and a wax powder. When combined with a coating composition or elements of a coating composition, the filler packages may improve abrasion resistance of the resulting coating composition upon curing to form a film, without compromising other properties of the coating composition.

The inorganic particulate component is included in the coating composition to improve the abrasion resistance of the coating composition upon curing. The inorganic particulate component has a D90 nominal particle dimension of from about 12 microns to about 22 microns, alternatively from about 12 microns to about 20 microns, alternatively from about 12 microns to 18 microns, alternatively from about 12 microns to about 15 microns, as measured using a sieve in accordance with ASTM 5861-07 (2017). It has been found that the inorganic particulate component having a D90 nominal particle dimension of from about 12 microns to about 22 microns contributes to abrasion resistance of the coating composition upon curing to form a film without creating an undesirable surface texture in the film.

The inorganic particulate component may comprise particles having various shapes. For example, the particles may have a spherical, spheroidal, cylindrical, geometric, or irregular shape. In embodiments, the inorganic particulate component comprises particles that all have the same general shape. In embodiments, the inorganic particulate component may have a hardness value of from about 4 to about 8, alternatively from about 4 to about 7, alternatively from about 5 to about 8, alternatively from about 5 to about 7, on the Mohs hardness scale.

In embodiments, the inorganic particulate component comprises metal silicate particulates, tungsten carbide particulates, calcium phosphate particulates, magnesium oxide particulates, barium titanate particulates, or a combination thereof. For example, the metal silicate particulates may comprise aluminum silicate, magnesium silicate, zirconium silicate, or a combination thereof. In embodiments, the inorganic particulate component comprises silica (SiO₂) particulates. The silica particulates may be coated with a metal such as silver or with another material.

In embodiments, the inorganic particulate component is present in an amount of from about 0.1 wt % to about 5.0 wt %, alternatively from about 0.5 wt % to about 4.0 wt %, alternatively from about 0.5% wt% to about 2.0 wt %, based on a total weight of the coating composition.

The wax powder is included in the coating composition to improve the abrasion resistance of the coating composition upon curing. The wax powder may also help maintain desirable flow properties of the coating composition. As used herein, “wax” refers to an organic compound. Within the coating composition, the wax powder is present as a distinct phase that is separate from the hydroxyl-functional resin, the crosslinking agent, and any reaction product of the hydroxyl-functional resin and the crosslinking agent that may be present.

In embodiments, the wax powder has an average nominal particle dimension of from about 10 microns to about 30 microns, alternatively from about 10 microns to about 25 microns, alternatively from about 20 microns to about 25 microns, as measured using a sieve in accordance with ASTM 5861-07 (2017). In embodiments, the wax powder has a softening point of from about 100° C. to about 200° C., alternatively from about 140° C. to about 190° C., alternatively from about 150° C. to about 180° C. As used herein, the “softening point” of a polymer refers to the Ring and Ball softening point, measured in accordance with ASTM E28.

In embodiments, the wax powder may comprise a natural wax, or alternatively, the wax powder may comprise a synthetic wax. In embodiments, the wax powder may comprise long-chain aliphatic hydrocarbons. In embodiments, the wax power may comprise functional groups such as fatty acids, primary and secondary alcohols, ketones, aldehydes, and fatty acid esters. In embodiments, the wax powder comprises polyethylene, polypropylene, polyamide, polytetrafluoroethylene, or combinations thereof. The particles of the wax powder include the recited components in an amount of at least 95 wt %, alternatively at least 99 wt %, based on the total weight of the particles.

In embodiments, the wax powder is present in an amount of from about 0.1 wt % to about 5.0 wt %, alternatively from about 0.5 wt % to about 4.0 wt %, alternatively from about 1.0 wt % to about 3.0 wt %, based on a total weight of the coating composition.

In embodiments, the coating composition further comprises an acid catalyst. The acid catalyst may be included in the coating composition to speed up the reaction of the hydroxyl-functional resin and the crosslinking agent during curing of the coating composition. Presence of the acid catalyst may be particularly advantageous when the crosslinking agent is a melamine. In embodiments, the acid catalyst is hydrophobic. In embodiments, the acid catalyst comprises a sulfonic acid, a phosphoric acid, benzoic acid, or a combination thereof. Examples of sulfonic acids include aromatic sulfonic acids, such as dodecylbenzene sulfonic acid, para-toluenesulfonic acid, and dinonylnaphthalene sulfonic acid. The acid catalyst may be unblocked or alternatively may be blocked with an amine, such as dimethyl oxazolidine, 2-amino-2-methyl-1-propanol, n,n-dimethylethanolamine, or a combination thereof. The acid catalyst may be present in a catalytically active amount. In embodiments, the acid catalyst may be present in an amount of from about 0.1 wt % to about 10 wt %, alternatively from about 1.0 wt % to about 9.0 wt %, alternatively from about 3.0 wt % to about 8.0 wt %, based on a total weight of the coating composition.

In embodiments, the coating composition further comprises a pigment. The pigment has a different hardness and/or a different particle dimension than the inorganic particulate component. The pigment may be included in the coating composition to improve the appearance of the film formed upon curing of the coating composition. In embodiments, the pigment may comprise a color pigment and/or an extender pigment. Color pigments may be inorganic color pigments, organic color pigments, and/or naturally occurring color pigments. Examples of inorganic color pigments include titanium dioxide (TiO₂), iron oxides, chromium oxide (Cr₂O₃), and cobalt. Examples of organic color pigments include azo pigments, quinacridone pigments, dioxazine pigments, and anthraquinone pigments. Examples of naturally occurring color pigments include ochre, indigo, and chlorophyll. Examples of extender pigments include calcium carbonate (CaCO₃), Talc (Mg₃Si₄O₁₀(OH)₂), barium sulfate (BaSO₄), mica, and zinc oxide (ZnO). In embodiments, the pigment is present in an amount to from about 1.0 wt % to about 30 wt %, alternatively from about 5.0 wt % to about 25 wt %, alternatively from about 10 wt % to about 20 wt %, based on a total weight of the coating composition.

In embodiments, the coating composition may further comprise other additives different from the inorganic particulate component, the wax powder, and the pigment. The additives may include rheology additives, pigment dispersants, antioxidants, U.V. absorbers, light stabilizers, leveling agents, antifoaming agents, and adhesion promoting agents, provided that the additional additives do not overlap with the categories of the aforementioned components. To the extent a component meets the requirements of the filler package, the component is considered part of the filler package and is not considered a separate additive.

In embodiments, the coating composition has a dynamic viscosity of no more than about 150 cPs, as measured with a total solids of 50%, using a Brookfield viscometer at 100 rpm using an LV spindle number 2 at 24° C. The recited dynamic viscosity values are considered desirable flow properties for the coating composition, making it easy to apply the coating composition to a substrate using existing application methods such as spray application or brush application.

The composite articles provided herein comprise a substrate and a film formed from the coating composition described herein. The substrate may comprise wood, plastic, metal, and/or other materials. The substrate may be multi-layer, and there may be other coatings provided that the film formed from the coating composition described herein is a show surface or outermost layer of the article. The substrate may be a household item, an automotive part, or an industrial machine part. In embodiments, the substrate may be a piece of household furniture such as a door, drawer, cabinet, leg, seat, table, or baseboard, particularly an article that may be subject to abrasion during usage.

The film is included in the composite article to improve one or more characteristics of the substrate, such as appearance, strength, or chemical resistance. In embodiments, the film comprises a substantially crosslinked thermoset polymer formed by the reaction of the hydroxyl-functional resin and the crosslinking agent, optionally in the presence of heat and/or the acid catalyst.

In embodiments, the composite article has an abrasion resistance such that no marks are present on a surface of the composite article based on a visual observation at a distance of three feet from the composite article in a room with standard lighting, and the measured gloss value changes by less than 5 gloss points, as measured in accordance with ASTM D523-12 using a glossmeter at a 60 degree angle, after the composite article is tested using a heavy duty linear abraser with a 1000 grit scrubbing pad as the test media for 521 cycles with 2200 grams of weight.

The methods provided herein are directed to forming the composite articles described herein. The methods comprise applying the coating composition described herein to a substrate to form a film and curing the film. Applying the coating composition to the substrate may comprise application through existing methods such as spray application, brush application, or roller application. The combination of the ability to be applied through spray application methods and the abrasion resistance of the film upon curing of the coating composition are unique benefits of the coating composition described herein. The coating composition may be applied to the substrate manually by a human or automatically by a machine. In embodiments in which the coating composition is a 1k composition, the coating composition may be applied directly to the substrate without a mixing step. In embodiments in which the coating composition is a 2k composition, the method may further comprise combining and/or mixing together two separate components before applying the resulting coating composition to the substrate.

Curing the film may comprise applying heat to the film. For example, the film may be exposed to a temperature of from about 50° C. to about 100° C. for a period of from about 4 minutes to about 10 minutes, or alternatively, the film may be exposed to a temperature of from about 25° C. to about 50° C. for a period of from about 45 minutes to about 75 minutes. Curing the coating composition effectuates a reaction between the hydroxyl-functional resin and the crosslinking agent, which transforms the coating composition from a flowable material to a substantially crosslinked thermoset material.

### EXAMPLES

### Examples 1-4

Four coating compositions were prepared as shown in Table 1 below. The coating compositions of Examples 1-3 are comparative examples not in accordance with this disclosure. The coating composition of Example 4 is a coating composition in accordance with this disclosure.

TABLE 1
Content of Coating Composition

| | | | | Acid | Inorganic | | | |
|---|---|---|---|---|---|---|---|---|
| | Resin | Crosslinking | Solvent | Catalyst | Particulate | Wax | | |
| | A | Agent A | A | A | Component A | Powder A | Pigment A | Additive A |
| Comparative | 20% | 8% | 44% | 7% | 0% | 0% | 20% | 1% |
| Example 1 | | | | | | | | |
| Comparative | 20% | 8% | 44% | 7% | 0% | 2% | 18% | 1% |
| Example 2 | | | | | | | | |
| Comparative | 20% | 8% | 44% | 7% | 1% | 0% | 19% | 1% |
| Example 3 | | | | | | | | |
| Example 4 | 20% | 8% | 44% | 7% | 1% | 2% | 17% | 1% |

In Table 1, the percentages represent weight percentages of each element, based on a total weight of the respective coating composition.

Resin A is a blend of an acrylic resin with a weight average molecular weight of from about 6,000 Daltons to about 30,000 Daltons, a glass transition temperature (Tg) of from about 10° C. to about 60° C., and an OH value of from about 50 mg KOH/g to about 150 mg KOH/g, commercially available from Axalta Coating Systems Ltd., and an alkyd resin with an OH value of from about 140 mg KOH/g to about 190 mg KOH/g, commercially available from Polimeros Sinteticos, S.A. de C.V.

Crosslinking Agent A is an alkylated melamine crosslinking agent, with an equivalent weight of about 75 grams/eq., commercially available from Allnex GMBH.

Solvent A is a blend of solvents including isobutyl acetate, butyl acetate, propylene glycol monomethyl ether acetate, butyl alcohol, isobutyl alcohol, isopropyl alcohol, ethyl alcohol, methyl amyl ketone, methyl ethyl ketone, xylene, and toluene.

Acid Catalyst A is a sulfonic acid catalyst, commercially available from Allnex GMBH.

Inorganic Particulate Component A is 3M Ceramic Microspheres, which is an aluminum silicate inorganic particulate component having a D90 nominal dimension of 12 microns, as measured using a sieve in accordance with ASTM 5861-07 (2017), and a hardness of 6 on the Mohs hardness scale.

Wax Powder A is a polyethylene wax powder, commercially available from Micro Powders, Inc., having a softening point of 150 to 180° C. and average nominal particle dimension of 10-25 microns, as measured using a sieve in accordance with ASTM 5861-07 (2017).

Pigment A is a blend of titanium dioxide and talc.

Additive A is polyether-modified polymethylsiloxane and cellulose acetate butyrate.

Each coating composition was tested for flowability. The dynamic viscosity of the coating compositions was measured with a total solids of 50%, using a Brookfield viscometer at 100 rpm using an LV spindle number 2 at 24° C.

Then, each coating composition was applied to a kitchen cabinet door and cured at a temperature of 65° C. for a period of 5 minutes to form a composite article corresponding to each coating composition. Each composite article was tested for abrasion resistance, adhesion, and yellowing as described below. The results are shown in Table 2 below.

The abrasion resistance of the cured coating was measured using a Taber Heavy Duty Linear Abraser Model 5800 with a blue Scotch Brite pad (1000 grit scrubbing pad) as the test media. The linear abraser was run for 521 cycles with 2200 grams of weight. Then, the composite article was visually observed at a distance of three feet from the composite article in a room with standard lighting, and the gloss was measured in accordance with ASTM method D523-14 using a glossmeter at a 60 degree angle. The adhesion of the cured coating to the substrate was measured by the cross hatch/tape pull method as described in ASTM 3359. The yellowing of the cured coating was measured by Color Spectrophotometer Datacolor 800 using method described by ASTM G154.

| | Abrasion | Dynamic | | |
|---|---|---|---|---|
| | Resistance | Viscosity/Flowability | Adhesion | Yellowing |
| Comparative | 1 | 3 | 3 | 3 |
| Example 1 | | | | |
| Comparative | 2 | 3 | 3 | 3 |
| Example 2 | | | | |
| Comparative | 3 | 2 | 3 | 3 |
| Example 3 | | | | |
| Example 4 | 3 | 3 | 3 | 3 |

In Table 1, a rating of 1 means that the performance is well below customer specifications. A rating of 2 means that the performance does not meet customer specifications but is better than a rating of 1. A rating of 3 means that the performance meets or exceeds customer specifications. Specifically, a rating of 1 for flowability means that the dynamic viscosity of the coating composition is in a range of from about 150 cPs to about 400 cPs, and that the coating composition is not sprayable using Kremlin AVX 12-174 tip or equivalent. A rating of 2 for flowability means that the dynamic viscosity of the coating composition is in a range of from about 150 cPs to about 200 cPs, and that the coating composition is not sprayable using Kremlin AVX 12-174 tip or equivalent. A rating of 3 for flowability means that the dynamic viscosity of the coating composition is in a range of from about 50 cPs to about 150 cPs, and that the coating composition is sprayable using Kremlin AVX 12-174 tip or equivalent. A rating of 1 for abrasion resistance means that the measured gloss value experienced a change of greater than 10 gloss points. A rating of 2 for abrasion resistance means that the measured gloss value experienced a change greater than 5 gloss points. A rating of 3 for abrasion resistance means that no marks are present on a surface of the composite article based on a visual observation at a distance of three feet from the composite article in a room with standard lighting, and the measured gloss value experienced a change of less than 5 gloss points. A rating of 1 for adhesion means a cross hatch rating between 1B to 2B. A rating of 2 for adhesion means a cross hatch rating between 2B to less than 4B. A rating of 3 for adhesion means a cross hatch rating greater than or equal to 4B. A rating of 1 for yellowing means a CIELAB dB color change of greater than 0.70. A rating of 2 for yellowing means a CIELAB dB color change of greater than 0.40. A rating of 3 for yellowing means a CIELAB dB color change of less than 0.40.

The results of Examples 1-4 show that only the composition containing both the inorganic particulate component (the 3M Ceramic Microspheres) and the wax powder (the polyethylene wax) (Example 4) meets customer specifications for all categories. The composition with neither the wax powder nor the inorganic particulate component (Comparative Example 1) is well below customer specifications for abrasion resistance. The composition with the wax powder but not the inorganic particulate component (Comparative Example 2) still does not meet customer specifications for abrasion resistance. The composition with the inorganic particulate component but not the wax powder (Comparative Example 3) meets customer specifications for abrasion resistance but has poor flow properties. The results suggest an unexpected synergy between the inorganic particulate component and the wax powder when combined with the hydroxyl-functional resin, the crosslinking agent, and the solvent.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment of the present disclosure. It being understood that various changes may be made in the function and arrangement of elements described in an exemplary embodiment without departing from the scope of the present disclosure as set forth in the appended claims.

What is claimed is:

1. A coating composition, comprising:
a hydroxyl-functional resin having a plurality of free hydroxyl groups;
a crosslinking agent having a hydroxyl-reactive functional group;
a solvent;
an inorganic particulate component having a D90 nominal particle dimension of from about 12 microns to about 22 microns, as measured using a sieve in accordance with ASTM 5861-07 (2017); and
a wax powder.

2. The coating composition of claim 1, wherein the inorganic particulate component has a hardness value from about 4 to about 8 on the Mohs hardness scale.

3. The coating composition of claim 1, wherein the inorganic particulate component comprises metal silicate particulates.

4. The coating composition of claim 3, wherein the metal silicate particulates comprise aluminum silicate, magnesium silicate, zirconium silicate, or a combination thereof.

5. The coating composition of claim 1, wherein the inorganic particulate component is present in an amount of from about 0.5 wt % to about 4.0 wt %, based on a total weight of the coating composition.

6. The coating composition of claim 1, wherein the wax powder has an average nominal particle dimension of from about 10 microns to about 25 microns, as measured using a sieve in accordance with ASTM 5861-07 (2017).

7. The coating composition of claim 1, wherein the wax powder has a softening point of from about 150° C. to about 180° C.

8. The coating composition of claim 1, wherein the wax powder comprises polyethylene, polypropylene, polyamide, polytetrafluorethylene, or combinations thereof.

9. The coating composition of claim 1, wherein the wax powder is present in an amount of from about 0.5 wt % to about 4.0 wt %, based on a total weight of the coating composition.

10. The coating composition of claim 1, further comprising an acid catalyst.

11. The coating composition of claim 10, wherein the acid catalyst comprises a sulfonic acid, a phosphoric acid, benzoic acid, or a combination thereof.

12. The coating composition of claim 1, further comprising a pigment having a hardness and/or particle dimension different from that of the inorganic particulate component.

13. The coating composition of claim 1, having a dynamic viscosity of no more than about 150 cPs, as measured with a total solids of 50%, using a Brookfield viscometer at 100 rpm using an LV spindle number 2 at 24° C.

14. The coating composition of claim 1, wherein the hydroxyl-functional resin comprises acrylic resins, alkyd resins, polyester resins, hydroxyl-functional polyepoxide resins, polyesterurethane resins, urea-formaldehyde resins, or a combination thereof.

15. The coating composition of claim 1, wherein the crosslinking agent is selected from polyisocyanates, blocked polyisocyanates, melamines, melamine derivatives, benzoguanamines, silanes, epoxides, and combinations thereof.

16. A composite article, comprising:
a substrate; and
a film formed from the coating composition of claim 1.

17. The composite article of claim 16, having an abrasion resistance such that no marks are present on a surface of the composite article based on a visual observation at a distance of three feet from the composite article in a room with standard lighting, and the measured gloss value changes by less than 5 gloss points, as measured in accordance with ASTM D523-12 using a glossmeter at a 60 degree angle, after the composite article is tested using a heavy duty linear abraser with a 1000 grit scrubbing pad as the test media for 521 cycles with 2200 grams of weight.

18. The composite article of claim 16, wherein the film comprises a substantially crosslinked thermoset polymer formed by reaction of the hydroxyl-functional resin and the crosslinking agent.

19. A method of forming a composite article, comprising:
applying the coating composition of claim 1 to a substrate to form a film; and
curing the film.

20. A filler package for use in a coating composition, comprising:
an inorganic particulate component, having a hardness value from about 4 to about 8 on the Mohs hardness scale and having a D90 nominal particle dimension of from about 12 microns to about 22 microns, as measured using a sieve in accordance with ASTM 5861-07 (2017); and
a wax powder having a softening point of from about 150°° C. to about 180° C. and having an average nominal particle dimension of from about 20 microns to about 25 microns, as measured using a sieve in accordance with ASTM 5861-07 (2017).
